(19) United States
(12) Patent Application Publication
(10) Pub. No.: US 2007/0216607 A1
(43) Pub. Date: Sep. 20, 2007

(54) Driving a plasma display panel (PDP)

(76) Inventors: Jung-Pil Park, Suwon-si (KR); Sang-Min Nam, Suwon-si (KR); Nam-Sung Jung, Suwon-si (KR)

Correspondence Address: Robert E. Bushnell, Suite 300, 1522 K Street, N.W., Washington, DC, 20005-1202, US

(21) Appl. No.: 11/645,627

(22) Filed: Dec. 27, 2006

(30) Foreign Application Priority Data
Mar. 14, 2006 (KR) 10-2006-0023516

(51) Int. Cl. G09G 3/28

(52) U.S. Cl. 345/67

(57) ABSTRACT

A method of driving a Plasma Display Panel (PDP) includes: arranging discharge cells in the PDP to each include sustain electrode lines and address electrode lines crossing each other; defining a display period in which each frame includes a plurality of subfields, each subfield having a corresponding gray scale weight for displaying a time division gray scale and a reset period, an address period, and a sustain-discharge period; biasing the sustain electrode lines to a first level; sequentially supplying a scan pulse of a second level to the sustain electrode lines and a data pulse synchronized with the scan pulse to the address electrode lines corresponding to selected discharge cells in the address period; and supplying a sustain pulse of a third level voltage and a sustain pulse of a fourth level voltage to the sustain electrode lines in the sustain-discharge period; the second level voltage and the fourth level voltage are supplied by the same power source.

### CLAIM OF PRIORITY

This application makes reference to, incorporates the same herein, and claims all benefits accruing under 35 U.S.C.§119 from an application for METHOD AND APPARATUS FOR DRIVING PLASMA DISPLAY PANEL earlier filed in the Korean Intellectual Property Office on the 14^{th} of Mar. 2006 and there duly assigned Ser. No. 10-2006-0023516.

### BACKGROUND OF THE INVENTION

1. Field of the Invention

The present invention relates to driving a Plasma Display Panel (PDP), and more particularly, the present invention relates to a PDP and a method of driving a PDP in which a frame constituting a display period is divided into a plurality of subfields for a time division gray scale display, and each subfield includes a reset period, an address period, and a sustain-discharge period.

2. Description of the Related Art

Plasma Display Panels (PDPs) have come to public attention because they can be easily manufactured as large-sized flat panel displays. A PDP represents images using a discharge phenomenon. Generally, PDPs can be classified into DC PDPs and AC PDPs according to the driving voltage. Since DC PDPs have a long discharge delay time, the current focus is on the development of AC PDPs.

A representative AC PDP is a 3-electrode AC surface discharge PDP which includes three electrode groups and is driven by AC voltages. Since a 3-electrode surface discharge PDP, which is composed of a plurality of plates, is thinner and lighter than a conventional Cathode Ray Tube (CRT), the 3-electrode surface discharge PDP can provide a large-sized screen.

A conventional 3-electrode surface discharge PDP and a driving apparatus and method thereof are discussed in U.S. Pat. No. 6,744,218 entitled “Method of Driving a Plasma Display Panel in which the Width of Display Sustain Pulse Varies”.

The PDP discussed in the afore-cited patent includes a plurality of display cells in which sustain electrodes and address electrodes cross each other, wherein each display cell consists of three (red, green, and blue) discharge cells. A gray scale of an image is represented by adjusting discharge states of the discharge cells.

In order to represent the gray scale of the PDP, each of the frames supplied to the PDP is divided into 8 subfields having different light-emitting frequencies, thereby representing 256 gray scales. In order to display an image using 256 gray scales, a frame period (16.67 ms) corresponding to 1/60 second is divided into 8 subfields.

Each subfield is divided into a reset period for initializing all of the discharge cells, an address period for selecting display cells, and a sustain-discharge period for displaying a discharge in the discharge cells selected in the address period.

In the address period, a scan pulse is sequentially supplied to each scan electrode, a data pulse synchronized with the scan pulse is supplied to address electrodes corresponding to the discharge cells that are to be displayed to select the discharge cells that are to be displayed from all of the discharge cells. Before the scan pulse is supplied to each scan electrode in the address period, all of the scan electrodes are biased by a biasing voltage, and then a scan pulse having a lower scan voltage than the biasing voltage is sequentially supplied to each scan electrode.

The scan voltage can have a lower level than a ground level. In this case, when a falling ramp voltage is supplied for a scan discharge and a reset discharge, a voltage lower than a ground voltage and higher than the scan voltage can be supplied to the electrode lines through a body diode of a switching device. Therefore, the switching device and a circuitry unit annexed thereto are required to prevent an undesired power source from being supplied. Also, a power supply having another voltage is required.

### SUMMARY OF THE INVENTION

The present invention provides a Plasma Display Panel (PDP) and a method of driving the PDP that uses a negative sustain voltage as a scan voltage of a scan pulse having a negative level in order to prevent a voltage lower than a ground voltage and higher than the scan voltage from being supplied to the electrode lines through a body diode of a switching device.

According to one aspect of the present invention, a method of driving a Plasma Display Panel (PDP)is provided, the method including: arranging discharge cells in the PDP to each include sustain electrode lines and address electrode lines crossing each other; defining a display period in which each frame includes a plurality of subfields, each subfield having a corresponding gray scale weight for displaying a time division gray scale and a reset period, an address period, and a sustain-discharge period; biasing the sustain electrode lines to a first level; sequentially supplying a scan pulse of a second level to the sustain electrode lines and a data pulse synchronized with the scan pulse to the address electrode lines corresponding to selected discharge cells in the address period; and supplying a sustain pulse of a third level voltage and a sustain pulse of a fourth level voltage to the sustain electrode lines in the sustain-discharge period; the second level voltage and the fourth level voltage are supplied by the same power source.

The second level voltage and the fourth level voltage are of the same voltage level.

In the reset period, all of the discharge cells are preferably initialized, discharge cells that are to be displayed are preferably selected by an address discharge performed using the scan pulse and the address pulse in the address period, and a sustain discharge is preferably performed in the discharge cells selected in the sustain-discharge period.

The sustain discharge is preferably performed between the sustain electrode lines and the address electrode lines.

The first level voltage and the third level voltage are preferably positive voltage levels, and the second level voltage and the fourth level voltage are preferably negative voltage levels.

The third level voltage and the fourth level voltage preferably have the same magnitude and opposite polarity.

According to another aspect of the present invention, a method of driving a Plasma Display Panel (PDP)is provided, the method including: arranging discharge cells in the PDP to each include X electrode lines, Y electrode lines, and address electrode lines crossing each other; defining a display period in which each frame includes a plurality of subfields, each subfield having a corresponding gray scale weight for displaying a time division gray scale and a reset period, an address period, and a sustain-discharge period; biasing the Y electrode lines to a first level; sequentially supplying a scan pulse of a second level to the Y electrode lines and a data pulse synchronized with the scan pulse to the address electrode lines corresponding to selected discharge cells in the address period; and supplying a sustain pulse having a third level voltage and a sustain pulse having a fourth level voltage to the Y electrode lines in the sustain-discharge period; the second level voltage and the fourth level voltage are supplied by the same power source.

The second level voltage and the fourth level voltage are preferably the same voltage level.

In the reset period, all of the discharge cells are preferably initialized, discharge cells that are to be displayed are preferably selected by an address discharge performed using the scan pulse and the address pulse in the address period, and a sustain discharge is preferably performed in the discharge cells selected in the sustain-discharge period.

The sustain discharge is preferably performed between the Y electrode lines and the X electrode lines.

The first level voltage and the third level voltage are preferably positive voltage levels, and the second level voltage and the fourth level voltage are preferably negative voltage levels.

The third level voltage and the fourth level voltage preferably have the same magnitude and opposite polarity.

According to yet another aspect of the present invention, a Plasma Display Panel (PDP) is provided including: discharge cells arranged to each include sustain electrode lines and address electrode lines crossing each other; each frame is a display period including a plurality of subfields, each subfield having a corresponding gray scale weight for displaying a time division gray scale and a reset period, an address period, and a sustain-discharge period; a driver adapted to: bias the sustain electrode lines to a first level; sequentially supply a scan pulse of a second level to the sustain electrode lines and a data pulse synchronized with the scan pulse to the address electrode lines corresponding to selected discharge cells in the address period; and supply a sustain pulse having a third level voltage and a sustain pulse having a fourth level voltage to the sustain electrode lines in the sustain-discharge period; and a single power source supply adapted to supply both the second level voltage and the fourth level voltage.

In the reset period, all discharge cells are preferably initialized, discharge cells that are to be displayed are preferably selected by an address discharge performed using the scan pulse and the address pulse in the address period, a sustain discharge is preferably performed in the discharge cells selected in the sustain-discharge period, and the sustain discharge is preferably performed between the sustain electrode lines and the address electrode lines.

The first level voltage and the third level voltage are preferably positive voltage levels, and the second level voltage and the fourth level voltage are preferably negative voltage levels.

The third level voltage and the fourth level voltage preferably have the same magnitude and opposite polarity.

The PDP preferably further includes: a sustain driver including a first sustain voltage supplying unit adapted to supply the sustain pulse of the third level voltage to the sustain electrode lines and a second sustain voltage supplying unit adapted to supply the sustain pulse of the fourth level voltage to the sustain electrode lines.

The PDP preferably further includes: a panel capacitor connected between the sustain electrode lines and the address electrode lines; an energy recovery unit including: a first energy recovery unit adapted to charge the panel capacitor with the third level voltage and to recover energy from the panel capacitor charged to the third level voltage; and a second energy recovery unit adapted to charge the panel capacitor with the fourth level voltage and to recover energy from the panel capacitor charged to the fourth level voltage.

The first energy recovery unit and the second energy recovery unit preferably include: an energy storage unit adapted to either charge or to recover the charge from the panel capacitor; an energy recovery switching unit adapted to control the energy storage unit to charge and to recover the charge from the panel capacitor; and an inductor having two terminals, one terminal being connected to the energy recovery switching unit and another terminal connected to the panel capacitor.

The energy recovery switching unit preferably includes: a first control switch having two terminals, one terminal being connected to the energy storage unit and another terminal connected to an inductor; a second control switch connected in parallel to the first control switch; a first diode connected between the first control switch and the inductor and adapted to allow a flow of current from the first control switch to the inductor; and a second diode connected between the second control switch and the inductor and adapted to allow a flow of current from the inductor to the second control switch.

According to yet another aspect of the present invention, a Plasma Display Panel (PDP) is provided including: discharge cells arranged to include X electrode lines, Y electrode lines, and address electrode lines crossing each other; each frame is a display period including a plurality of subfields, each subfield having a corresponding gray scale weight for displaying a time division gray scale and a reset period, an address period, and a sustain-discharge period; a driver adapted to: bias the Y electrode lines to a first level; sequentially supply a scan pulse of a second level to the Y electrode lines and a data pulse synchronized with the scan pulse to the address electrode lines corresponding to selected discharge cells in the address period; and supply a sustain pulse having a third level voltage and a sustain pulse having a fourth level voltage to the Y electrode lines in the sustain-discharge period; and a power source adapted to supply both the second level voltage and the fourth level voltage.

In the reset period, all discharge cells are preferably initialized, discharge cells that are to be displayed are preferably selected by an address discharge performed using the scan pulse and the address pulse in the address period, a sustain discharge is preferably performed in the discharge cells selected in the sustain-discharge period, and the sustain discharge is preferably performed between the Y electrode lines and the X electrode lines.

The first level voltage and the third level voltage are preferably positive voltage levels, and the second level voltage and the fourth level voltage are preferably negative voltage levels.

The PDP preferably further includes: a sustain driver including a first sustain voltage supplying unit adapted to supply the sustain pulse of the third level voltage to the Y electrode lines and a second sustain voltage supplying unit adapted to supply the sustain pulse of the fourth level voltage to the Y electrode lines.

The PDP preferably further includes: a panel capacitor connected between the Y electrode lines and the X electrode lines; an energy recovery unit including: a first energy recovery unit adapted to charge the panel capacitor with the third level voltage and to recover energy from the panel capacitor charged to the third level voltage; and a second energy recovery unit adapted to charge the panel capacitor with the fourth level voltage and to recover energy from the panel capacitor charged to the fourth level voltage.

The first energy recovery unit and the second energy recovery unit preferably include: an energy storage unit adapted to either charge or to recover the charge from the panel capacitor; an energy recovery switching unit adapted to control the energy storage unit to charge and to recover the charge from the panel capacitor; and an inductor having two terminals, one terminal being connected to the energy recovery switching unit and another terminal being connected to the panel capacitor.

The energy recovery switching unit preferably includes: a first control switch having two terminals, one terminal being connected to the energy storage unit and another terminal being connected to an inductor; a second control switch connected in parallel to the first control switch; a first diode connected between the first control switch and the inductor and adapted to allow a flow of current from the first control switch to the inductor; and a second diode connected between the second control switch and the inductor and adapted to allow a flow of current from the inductor to the second control switch.

The third level voltage and the fourth level voltage preferably have the same magnitude and opposite polarity.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a perspective view of a 3-electrode surface discharge PDP to which a PDP driving apparatus according to an embodiment of the present invention is applied;

FIG. 2 is a block diagram of a PDP driving apparatus according to an embodiment of the present invention;

FIG. 3 is a timing diagram of a PDP driving method in which a unit frame is divided into a plurality of subfields, according to an embodiment of the present invention;

FIG. 4 is a timing diagram of driving signals output from each of the drivers of the PDP of FIG. 3 using the PDP driving method according to an embodiment of the present invention; and

FIG. 5 is a circuit diagram of a PDP driving apparatus driven using the PDP driving method of FIG. 4, according to an embodiment of the present invention.

### DETAILED DESCRIPTION OF THE INVENTION

The present invention is described more fully below with reference to the accompanying drawings, in which exemplary embodiments of the present invention are shown.

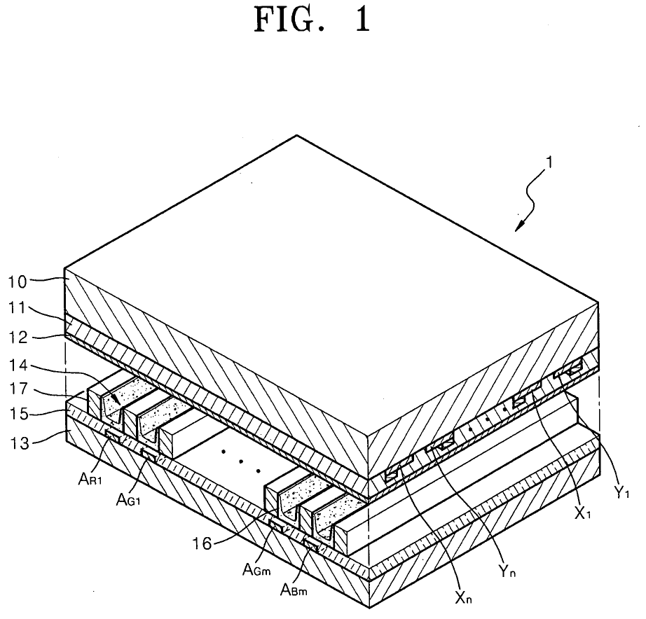

FIG. 1 is a perspective view of a 3-electrode surface discharge PDP 1 to which a PDP driving apparatus according to an embodiment of the present invention is applied.

Referring to FIG. 1, address electrodes A_{R1}, . . . , A_{Bm}, upper and lower dielectric layers 11 and 15, Y electrodes Y₁, . . . , Yₙ, X electrodes X₁, . . . , Xₙ, phosphor layers 16, barrier ribs 17, and a MgO layer 12 which is a protection layer, are formed between front and rear glass substrates 10 and 13 of the surface discharge PDP 1.

The address electrodes A_{R1}, . . . , A_{Bm} are formed in a predetermined pattern on an upper surface of the rear glass substrate 13. The lower dielectric layer 15 buries the address electrodes A_{R1}, . . . , A_{Bm}. The barrier ribs 17 are formed parallel to the address electrodes A_{R1}, . . . , A_{Bm} on a surface of the lower dielectric layer 15. The barrier ribs 17 partition discharge areas and prevent cross talk between the discharge areas. The phosphor layers 16 are formed on sidewalls of the barrier ribs 17 and on the lower dielectric layer 15 formed on the rear glass substrate 13.

The X electrodes X₁, . . . , Xₙ and the Y electrodes Y₁, . . . , Yₙ are formed in a predetermined pattern on a lower surface of the front glass substrate 10 such that they cross the address electrodes A_{R1}, . . . , A_{Bm}. Discharge cells 14 are defined where the X electrodes X₁, . . . , Xₙ and the Y electrodes Y₁, . . . , Yₙ intersect the address electrodes A_{R1}, . . . , A_{Bm}. Each of the X electrodes X₁, . . . , Xₙ and each of the Y electrodes Y₁, . . . , Yₙ are formed by coupling a transparent conductive electrode formed of a material, such as Indium Tin Oxide (ITO), with a metal electrode for increasing conductivity. The X electrodes X₁, . . . , Xₙ are common electrodes of the respective discharge cells 14, and the Y electrodes Y₁, . . . , Yₙ are scan electrodes of the respective discharge cells 14.

The Y electrodes Y₁, . . . , Yₙ are scan electrodes to which a scan pulse is sequentially supplied to select the discharge cells 14 that are to be displayed. The PDP driving apparatus according to the current embodiment of the present invention is applied to the 3-electrode PDP of FIG. 1, but is not necessarily limited thereto, and can also be applied to a ring discharge PDP in which electrodes surround discharge spaces in barrier ribs or a 2-electrode PDP comprising scan electrodes and address electrodes.

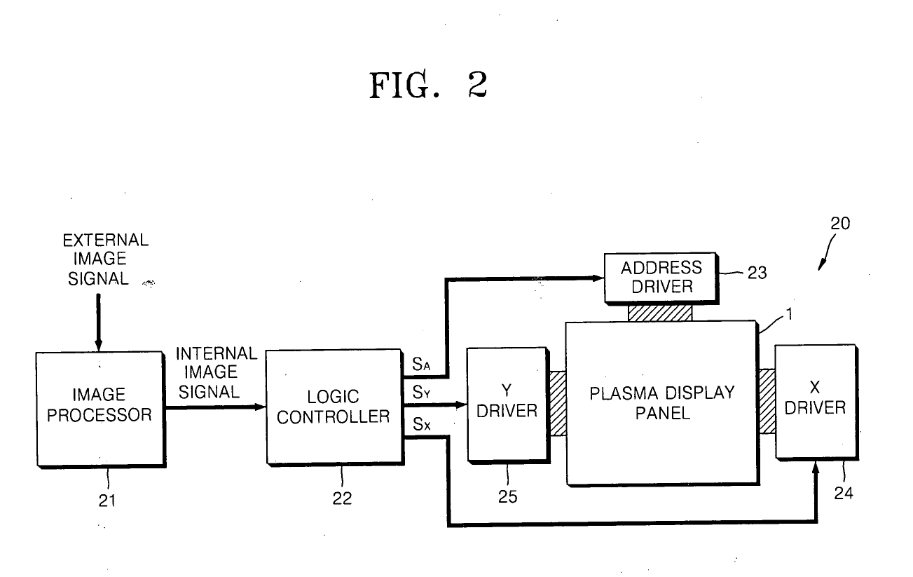

FIG. 2 is a block diagram of a PDP driving apparatus 20 according to an embodiment of the present invention.

Referring to FIG. 2, the PDP driving apparatus 20 includes an image processor 21, a logic controller 22, an address driver 23, an X driver 24, and a Y driver 25. The image processor 21 converts external analog image signals into digital signals and generates internal image signals, for example, red (R), green (G), and blue (B) image data signals, a clock signal, and vertical and horizontal synchronization signals. The logic controller 22 generates driving control signals S_{A}, S_{Y}, and S_{X} according to the internal image signals received from the image processor 26. The address driver 23, the X driver 24, and the Y driver 25 receive the driving control signals S_{A}, S_{Y}, and S_{X}, generate the corresponding driving control signals S_{A}, S_{Y}, and S_{X}, and supply the generated driving control signals S_{A}, S_{Y}, and S_{X} to the corresponding electrodes.

That is, the address driver 23 receives the address driving control signal S_{A} from the logic controller 22 and supplies a corresponding display data signal to the address electrodes. The X driver 24 processes the X driving control signal S_{X} received from the logic controller 22, and supplies a voltage corresponding to the X driving control signal S_{X} to the X electrodes. The Y driver 25 processes the Y driving control signal S_{Y} received from the logic controller 22, and supplies a voltage corresponding to the Y driving control signal S_{Y} to the Y electrodes.

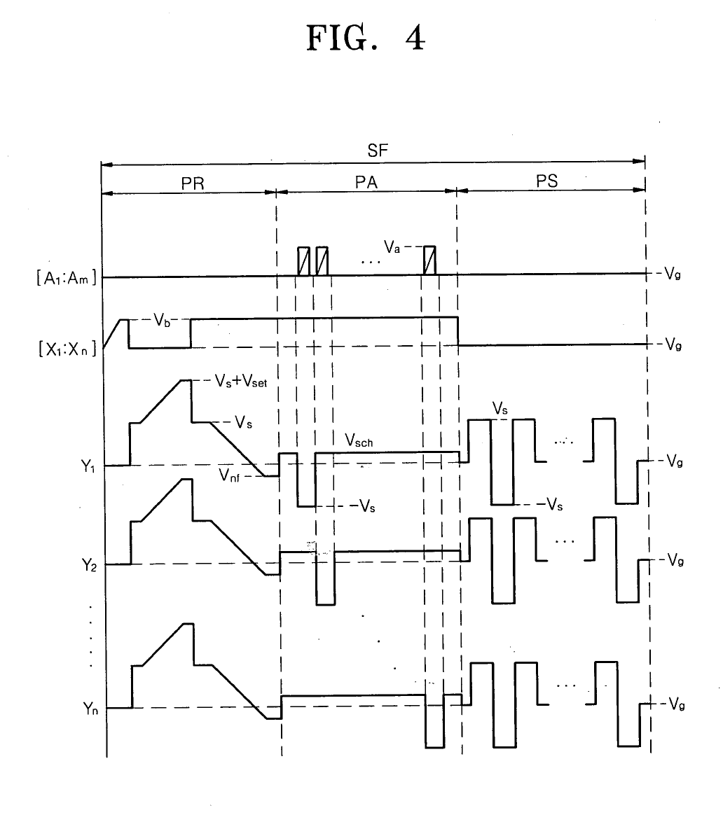

The PDP driving apparatus according to the present invention drives the PDP using a driving method of FIG. 4, described in detail below with reference to FIG. 4.

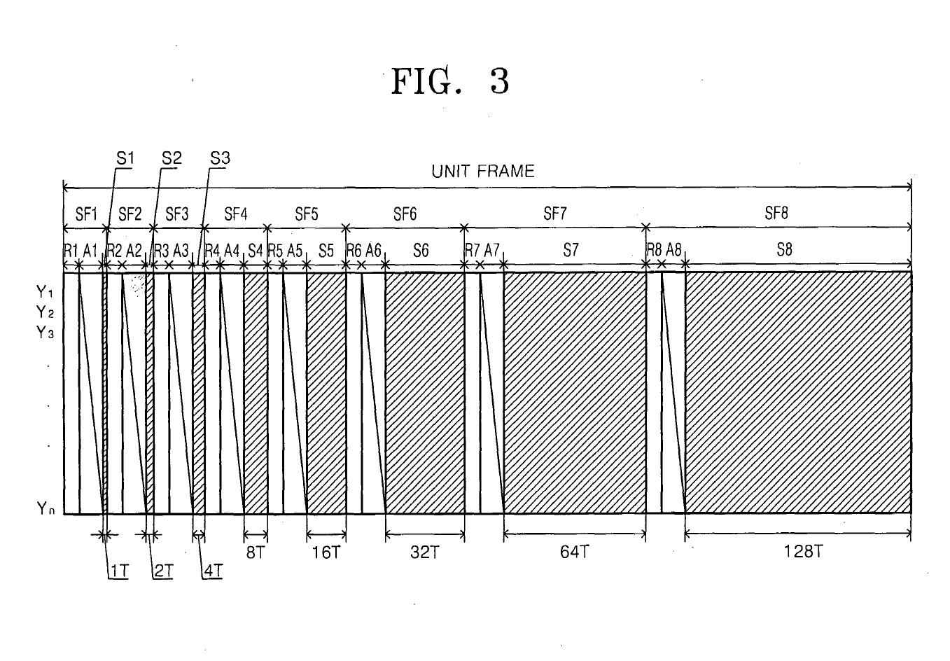

FIG. 3 is a timing diagram of a PDP driving method in which a unit frame is divided into a plurality of subfields, according to an embodiment of the present invention.

Referring to FIG. 3, the unit frame FR is divided into 8 subfields SF1, . . . , SF8 for a time division gray scale display. Also, the respective subfields SF1, . . . , SF8 are respectively divided into reset periods R1, . . . , R8, address periods A1, . . . , A8, and sustain discharge periods S1, . . . , S8.

The brightness of the PDP is proportional to the length of the sustain discharge periods S1, . . . , S8 in a unit frame. The length of the sustain discharge periods S1, . . . , S8 in a unit frame is 255 T (T is a unit time). A time corresponding to 2ⁿ is set to the sustain discharge period Sn of an n-^{th} subfield SFn. Accordingly, by appropriately selecting subfields to be displayed among 8 subfields, 256 gray scales including a zero gray scale which is not displayed in any subfield can be displayed.

FIG. 4 is a timing diagram of driving signals output from each of the drivers of the PDP 1 of FIG. 3 using the PDP driving method according to an embodiment of the present invention.

Referring to FIG. 4, a unit frame of the PDP 3 of FIG. 3 is divided into a plurality of subfields, wherein each subfield has a gray scale weight for driving time division gray scale display, and each subfield SF includes a reset period PR, an address period PA, and a sustain-discharge period PS.

In the reset period PR, a reset pulse including a rising pulse and a falling pulse is supplied to Y electrodes Y₁ through Yₙ and a second voltage (a bias voltage) is supplied to X electrodes X₁ through Xₙ to perform a reset discharge when the falling pulse is supplied. The reset discharge initializes all of the discharge cells. The rising pulse rises from a sustain-discharge voltage Vs through a rising voltage Vₛₑₜ to a rising maximum voltage Vₛₑₜ+Vs. The falling pulse falls from the sustain discharge voltage Vs to a falling maximum voltage V_{nf}.

In the address period PA, a scan pulse is sequentially supplied to the Y electrodes Y₁ through Yₙ, and a display data signal is supplied to A electrodes A1 through Aₘ in accordance with the scan pulse to perform an address discharge, so that the discharge cells for performing a sustain discharge in the sustain-discharge period PS can be selected. The scan pulse sequentially has a scan high voltage Vsch and a scan low voltage Vscl. The display data signal has a positive address voltage Va in accordance with the application of the scan low voltage Vscl of the scan pulse.

In the address period PA, the scan pulse having a second level, i.e., the scan low voltage Vscl is sequentially supplied to the Y electrodes Y₁ through Yₙ which are biased to a first level, i.e., the scan high voltage. A data pulse synchronized with the scan pulse is supplied to the A electrodes A₁ through Aₘ corresponding to the selected discharge cells. In more detail, the address discharge performed by the scan pulse and the address pulse selects the discharge cells that are to be displayed.

In the sustain-discharge period PS, a sustain pulse having a third level voltage Vs and a sustain pulse having a fourth level voltage −Vs are alternately supplied to sustain electrodes lines, i.e., Y electrodes Y₁ through Yₙ according to the current embodiment of the present invention or the X electrodes X₁ through Xₙ.

The first level and the third level can be positive levels and the second level and the fourth level can be negative levels.

Power is supplied from a power source supply terminal −Vs in which voltages of the second level and the fourth level are identical to each other. The PDP driving method according to the current embodiment of the present invention uses a negative sustain voltage −Vs as a scan voltage of the sustain pulse having a negative level when the PDP is sustain-driven using a single sustain driving method in which a sustain pulse having the same size of a positive voltage Vs and the negative voltage −Vs is alternately supplied to a electrode line, so that a voltage lower than a ground voltage and higher than the scan voltage is not supplied to the electrode line via a body diode of a switching device.

Accordingly, the switching device and a circuitry unit annexed to the switching device are not required to prevent an undesired power source from being supplied to the electrode line. Also, the scan low voltage Vscl and the negative scan pulse −Vs share a power source level, which does not require a power source supply unit to provide an additional power source level.

In the sustain-discharge period PS, the sustain discharge is performed in the selected discharge cells to present the brightness that is to be displayed in each of the selected discharge cells.

According to the current embodiment of the present invention, the sustain pulse is supplied to the Y electrodes Y₁ through Yₙ of the 3-electrode type PDP of FIG. 1, but it is not necessarily limited thereto, and can also be applied to a ring discharge PDP in which electrodes surround discharge spaces in barrier ribs or a 2-electrode PDP comprising scan electrodes and address electrodes.

In the 2-electrode PDP, the scan pulse is supplied to sustain electrodes in the address period PA, and the sustain pulse is supplied to the Y electrodes Y₁ through Yₙ in the sustain-discharge period PS. Also, the sustain discharge is performed between the sustain electrodes and address electrodes in the sustain-discharge period PS. According to anther embodiment of the present invention, the address electrodes can be the Y electrodes Y₁ through Yₙ to which the sustain pulse is supplied in the sustain-discharge period PS.

According to the current embodiment of the present invention, the driving signals of FIG. 4 are not necessarily limited thereto but other driving signals can be output from each of the drivers of FIG. 2.

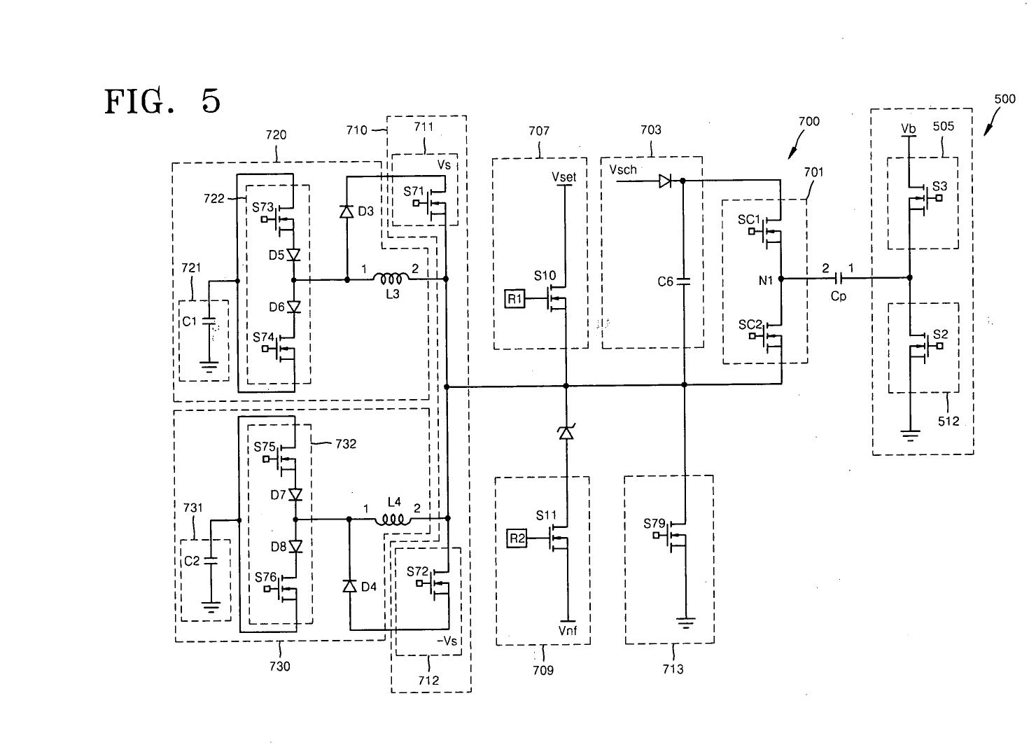

FIG. 5 is a circuit diagram of a PDP driving apparatus 700 driven using the PDP driving method of FIG. 4, according to an embodiment of the present invention.

Referring to FIG. 5, the PDP driving apparatus 700 includes a sustain driver 710 and energy recovery units 720 and 730. The PDP driving apparatus 700 drives a PDP using the PDP driving method of FIG. 4.

The sustain driver 710 includes a first sustain voltage supplying unit 711 and a second sustain voltage supplying unit 712. The first sustain voltage supplying unit 711 supplies a sustain pulse Vs of a third level to sustain electrode lines, e.g., Y electrodes Y₁ through Yₙ. The second sustain voltage supplying unit 712 supplies a sustain pulse −Vs of a fourth level to the sustain electrode lines, e.g., the Y electrodes Y₁ through Yₙ.

The first sustain voltage supplying unit 711 includes a control switch S71 that controls the connection between a first power supply terminal Vs and a panel capacitor Cp. The second sustain voltage sypplying unit 712 includes a control switch S72 that controls the connection between a second power supply terminal −Vs and the panel capacitor Cp. The first power supply terminal Vs and the second power supply terminal −Vs supply the same amount of power but have opposite polarities.

The energy recovery units 720 and 730 include a first energy recovery unit 720 and a second energy recovery unit 730. The first energy recovery unit 720 charges the panel capacitor Cp to a voltage Vs of a third level, and recovers energy from the panel capacitor CP charged to the voltage Vs of the third level. The second energy recovery unit 730 charges the panel capacitor Cp to a voltage −Vs of a fourth level, and recovers energy from the panel capacitor CP charged to the voltage −Vs of the fourth level.

The first energy recovery unit 720 includes a first energy storage unit 721, a first energy recovery switching unit 722, and a first inductor L3. The first energy storage unit 721 recovers or charges a charge from the panel capacitor Cp and includes an energy storage element which is a capacitor C1. The first energy recovery switching unit 722 controls the first energy storage unit 721 to recover or charge the charge from the panel capacitor Cp. One end of the first inductor L3 is connected to the first energy recovery switching unit 722, and another end of the first inductor L3 is connected to the panel capacitor Cp.

The first energy recovery switching unit 722 includes a first control switch S73, a second switch S74, a first diode D5, and a second diode D6. One end of the first control switch S73 is connected to the first energy storage unit 721, and another end of the first control switch S73 is connected to the first inductor L3. The second switch S74 is connected between the first control switch and the first inductor L3. One end of the second switch S74 is connected to the first energy storage unit 721, and another end of the second switch S74 is connected parallel to the first control switch S73.

The first diode D5 is connected between the first control switch S73 and the first inductor L3 so that a current flows from the first control switch S73 to the first inductor L3. The second diode D6 is connected between the second control switch S74 and the first inductor L3 so that a current flows from the first inductor L3 to the second control switch S74.

The second energy recovery unit 730 includes a second energy storage unit 731, a second energy recovery switching unit 732, and a second inductor L4. The second energy storage unit 731 recovers or charges a charge from the panel capacitor Cp and includes an energy storage element which is a capacitor C2. The second energy recovery switching unit 732 controls the second energy storage unit 731 to recover or charge the charge from the panel capacitor Cp. One end of the second inductor L4 is connected to the second energy recovery switching unit 732, and another end of the second inductor L4 is connected to the panel capacitor Cp.

The second energy recovery switching unit 732 includes a first control switch S75, a second switch S76, a first diode D7, and a second diode D8. One end of the first control switch S75 is connected to the second energy storage unit 731, and another end of the first control switch S75 is connected to the second inductor L4. One end of the second switch S76 is connected to the second energy storage unit 731, and another end of the second switch S76 is connected to the second inductor L4 and is connected parallel to the first control switch S75.

The first diode D7 is connected between the second control switch S75 and the second inductor L4 so that a current flows from the second control switch S75 to the second inductor L4. The second diode D8 is connected between the second control switch S76 and the second inductor L4 so that a current flows from the second inductor L4 to the second control switch S76.

The PDP driving apparatus 700 includes a scan switching unit 701, a third voltage supplying unit 707, a fourth voltage supplying unit 709, a fifth voltage supplying unit 703, and a ground voltage supplying unit 712.

The scan switching unit 701 includes a first scan switching device SC1 and a second scan switching device SC2, which are serially connected to each other. A node N1 formed between the first scan switching device SC1 and the second scan switching device SC2 is connected to Y electrodes (second ends of the panel capacitor Cp) of the PDP. The scan switching unit 701 can include a scan IC capable of controlling the power to be supplied to the Y electrodes. The scan switching unit 701 can include a plurality of scan ICs so that all of the Y electrodes are divided into a plurality of blocks and one scan IC can be connected to each of the blocks.

The fifth voltage supplying unit 703 includes a fifth voltage source Vsch, is connected to the first scan switching device SC1, and outputs a fifth voltage Vsch to the first scan switching device SC1. The ground voltage supplying unit 713 outputs a ground voltage Vg to the Y electrodes (second ends of the panel capacitor Cp) of the PDP through the second scan switching device SC2.

The third voltage supplying unit 707 includes a first ramp generator R1 and a tenth switching device S10. The tenth switching device S10 connects a third voltage source Vset to the Y electrodes (second ends of the panel capacitor Cp) of the PDP through the second scan switching device SC2. The first ramp generator R1 generates a rising ramp pulse waveform that rises from Vs to Vs+Vset in the reset period PR of the driving signals of FIG. 4.

The fourth voltage supplying unit 709 includes a second ramp generator R2 and an eleventh switching device S11. The eleventh switching device S11 connects a fourth voltage source Vnf to the Y electrodes (second ends of the panel capacitor Cp) of the PDP through the second scan switching device SC2. The second ramp generator R2 generates a falling ramp pulse waveform that falls from Vs to Vs+Vset in the reset period PR of the driving signals of FIG. 4.

The PDP driving apparatus 700 can be a Y driving circuit and further includes an X driving circuit 500 connected to the first end of the panel capacitor Cp. The X driving circuit 500 includes a seventh voltage supplying unit 505 and a ground voltage supplying unit 512.

The seventh voltage supplying unit 505 includes a third switching device S3 having one end connected to a seventh voltage source Vb and other end connected to X electrodes (first ends of the panel capacitor Cp) of the PDP. The third switching device S3 is turned on so that a second voltage Vb is output from the X electrodes (first ends of the panel capacitor Cp) of the PDP.

The ground voltage supplying unit 512 includes a second switching device S2 having one end connected to a ground end Vg and other end connected to the X electrodes (first ends of the panel capacitor Cp) of the PDP. The second switching device S2 is turned on so that a ground voltage Vb is output from the Y electrodes (second ends of the panel capacitor Cp) of the PDP.

The PDP driving method according to the current embodiment of the present invention uses a negative sustain voltage −Vs as a scan voltage of the sustain pulse having a negative level when the PDP is sustain-driven using a single sustain driving method in which a sustain pulse having the same amount of a positive voltage Vs and the negative voltage −Vs is alternately supplied to a electrode line, so that a voltage lower than a ground voltage and higher than the scan voltage is not supplied to the electrode line via a body diode of a switching device.

Accordingly, the switching device and circuitry conneced to the switching device are not required to prevent undesired power from being supplied to the electrode line. Also, the scan low voltage Vscl and the negative scan pulse −Vs share a power source level, which does not require a power source supply unit to provide an additional power source level.

In the sustain-discharge period PS, the sustain discharge is performed in the selected discharge cells to present the brightness that is to be displayed in each of the selected discharge cells.

According to the current embodiment of the present invention, the sustain pulse is supplied to the Y electrodes Y₁ through Yₙ of the 3-electrode PDP of FIG. 1, but is not necessarily limited thereto, and can also be applied to a ring discharge PDP in which electrodes surround discharge spaces in barrier ribs or a 2-electrode PDP including scan electrodes and address electrodes.

In the 2-electrode PDP, the scan pulse is supplied to sustain electrodes in the address period PA, and the sustain pulse is supplied to the Y electrodes Y₁ through Yₙ in the sustain-discharge period PS. Also, the sustain discharge is performed between the sustain electrodes and address electrodes in the sustain-discharge period PS. According to another embodiment of the present invention, the address electrodes can be the Y electrodes Y₁ through Yₙ to which the sustain pulse is supplied in the sustain-discharge period PS.

The PDP driving apparatus and method according to the current embodiment of the present invention uses a negative sustain voltage as a scan voltage of a scan pulse having a negative level so that a voltage lower than a ground voltage and higher than the scan voltage is not supplied to the electrode line via a body diode of a switching device.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A method of driving a Plasma Display Panel (PDP), comprising:
arranging discharge cells in the PDP to each include sustain electrode lines and address electrode lines crossing each other;
defining a display period in which each frame includes a plurality of subfields, each subfield having a corresponding gray scale weight for displaying a time division gray scale and a reset period, an address period, and a sustain-discharge period;
biasing the sustain electrode lines to a first level;
sequentially supplying a scan pulse of a second level to the sustain electrode lines and a data pulse synchronized with the scan pulse to the address electrode lines corresponding to selected discharge cells in the address period; and
supplying a sustain pulse of a third level voltage and a sustain pulse of a fourth level voltage to the sustain electrode lines in the sustain-discharge period;
wherein the second level voltage and the fourth level voltage are supplied by the same power source.

2. The method of claim 1, wherein the second level voltage and the fourth level voltage are of the same voltage level.

3. The method of claim 1, wherein, in the reset period, all of the discharge cells are initialized, discharge cells that are to be displayed are selected by an address discharge performed using the scan pulse and the address pulse in the address period, and a sustain discharge is performed in the discharge cells selected in the sustain-discharge period.

4. The method of claim 3, wherein the sustain discharge is performed between the sustain electrode lines and the address electrode lines.

5. The method of claim 1, wherein the first level voltage and the third level voltage are positive voltage levels, and the second level voltage and the fourth level voltage are negative voltage levels.

6. The method of claim 1, wherein the third level voltage and the fourth level voltage have the same magnitude and opposite polarity.

7. A method of driving a Plasma Display Panel (PDP), comprising:
arranging discharge cells in the PDP to each include X electrode lines, Y electrode lines, and address electrode lines crossing each other;
defining a display period in which each frame includes a plurality of subfields, each subfield having a corresponding gray scale weight for displaying a time division gray scale and a reset period, an address period, and a sustain-discharge period;
biasing the Y electrode lines to a first level;
sequentially supplying a scan pulse of a second level to the Y electrode lines and a data pulse synchronized with the scan pulse to the address electrode lines corresponding to selected discharge cells in the address period; and
supplying a sustain pulse having a third level voltage and a sustain pulse having a fourth level voltage to the Y electrode lines in the sustain-discharge period;
wherein the second level voltage and the fourth level voltage are supplied by the same power source.

8. The method of claim 7, wherein the second level voltage and the fourth level voltage are the same voltage level.

9. The method of claim 7, wherein, in the reset period, all of the discharge cells are initialized, discharge cells that are to be displayed are selected by an address discharge performed using the scan pulse and the address pulse in the address period, and a sustain discharge is performed in the discharge cells selected in the sustain-discharge period.

10. The method of claim 9, wherein the sustain discharge is performed between the Y electrode lines and the X electrode lines.

11. The method of claim 7, wherein the first level voltage and the third level voltage are positive voltage levels, and the second level voltage and the fourth level voltage are negative voltage levels.

12. The method of claim 7, wherein the third level voltage and the fourth level voltage have the same magnitude and opposite polarity.

13. A Plasma Display Panel (PDP), comprising:
discharge cells arranged to each include sustain electrode lines and address electrode lines crossing each other;
wherein each frame is a display period including a plurality of subfields, each subfield having a corresponding gray scale weight for displaying a time division gray scale and a reset period, an address period, and a sustain-discharge period;
a driver adapted to:
bias the sustain electrode lines to a first level;
sequentially supply a scan pulse of a second level to the sustain electrode lines and a data pulse synchronized with the scan pulse to the address electrode lines corresponding to selected discharge cells in the address period; and
supply a sustain pulse having a third level voltage and a sustain pulse having a fourth level voltage to the sustain electrode lines in the sustain-discharge period; and
a single power source supply adapted to supply both the second level voltage and the fourth level voltage.

14. The PDP of claim 13, wherein, in the reset period, all discharge cells are initialized, discharge cells that are to be displayed are selected by an address discharge performed using the scan pulse and the address pulse in the address period, a sustain discharge is performed in the discharge cells selected in the sustain-discharge period, and the sustain discharge is performed between the sustain electrode lines and the address electrode lines.

15. The PDP of claim 13, wherein the first level voltage and the third level voltage are positive voltage levels, and the second level voltage and the fourth level voltage are negative voltage levels.

16. The PDP of claim 13, wherein the third level voltage and the fourth level voltage have the same magnitude and opposite polarity.

17. The PDP of claim 13, further comprising: a sustain driver including a first sustain voltage supplying unit adapted to supply the sustain pulse of the third level voltage to the sustain electrode lines and a second sustain voltage supplying unit adapted to supply the sustain pulse of the fourth level voltage to the sustain electrode lines.

18. The PDP of claim 17, further comprising:
a panel capacitor connected between the sustain electrode lines and the address electrode lines;
an energy recovery unit including:
a first energy recovery unit adapted to charge the panel capacitor with the third level voltage and to recover energy from the panel capacitor charged to the third level voltage; and
a second energy recovery unit adapted to charge the panel capacitor with the fourth level voltage and to recover energy from the panel capacitor charged to the fourth level voltage.

19. The PDP of claim 18, wherein the first energy recovery unit and the second energy recovery unit comprise:
an energy storage unit adapted to either charge or to recover the charge from the panel capacitor;
an energy recovery switching unit adapted to control the energy storage unit to charge and to recover the charge from the panel capacitor; and
an inductor having two terminals, one terminal being connected to the energy recovery switching unit and another terminal connected to the panel capacitor.

20. The PDP of claim 19, wherein the energy recovery switching unit comprises:
a first control switch having two terminals, one terminal being connected to the energy storage unit and another terminal connected to an inductor;
a second control switch connected in parallel to the first control switch;
a first diode connected between the first control switch and the inductor and adapted to allow a flow of current from the first control switch to the inductor; and
a second diode connected between the second control switch and the inductor and adapted to allow a flow of current from the inductor to the second control switch.

21. A Plasma Display Panel (PDP), comprising:
discharge cells arranged to include X electrode lines, Y electrode lines, and address electrode lines crossing each other;
wherein each frame is a display period including a plurality of subfields, each subfield having a corresponding gray scale weight for displaying a time division gray scale and a reset period, an address period, and a sustain-discharge period;
a driver adapted to:
bias the Y electrode lines to a first level;
sequentially supply a scan pulse of a second level to the Y electrode lines and a data pulse synchronized with the scan pulse to the address electrode lines corresponding to selected discharge cells in the address period; and
supply a sustain pulse having a third level voltage and a sustain pulse having a fourth level voltage to the Y electrode lines in the sustain-discharge period;
a power source adapted to supply both the second level voltage and the fourth level voltage.

22. The PDP of claim 21, wherein, in the reset period, all discharge cells are initialized, discharge cells that are to be displayed are selected by an address discharge performed using the scan pulse and the address pulse in the address period, a sustain discharge is performed in the discharge cells selected in the sustain-discharge period, and the sustain discharge is performed between the Y electrode lines and the X electrode lines.

23. The PDP of claim 21, wherein the first level voltage and the third level voltage are positive voltage levels, and the second level voltage and the fourth level voltage are negative voltage levels.

24. The PDP of claim 13, further comprising: a sustain driver including a first sustain voltage supplying unit adapted to supply the sustain pulse of the third level voltage to the Y electrode lines and a second sustain voltage supplying unit adapted to supply the sustain pulse of the fourth level voltage to the Y electrode lines.

25. The PDP of claim 24, further comprising:
a panel capacitor connected between the Y electrode lines and the X electrode lines;
an energy recovery unit including:
a first energy recovery unit adapted to charge the panel capacitor with the third level voltage and to recover energy from the panel capacitor charged to the third level voltage; and
a second energy recovery unit adapted to charge the panel capacitor with the fourth level voltage and to recover energy from the panel capacitor charged to the fourth level voltage.

26. The PDP of claim 25, wherein the first energy recovery unit and the second energy recovery unit comprise:
an energy storage unit adapted to either charge or to recover the charge from the panel capacitor;
an energy recovery switching unit adapted to control the energy storage unit to charge and to recover the charge from the panel capacitor; and
an inductor having two terminals, one terminal being connected to the energy recovery switching unit and another terminal being connected to the panel capacitor.

27. The PDP of claim 26, wherein the energy recovery switching unit comprises:
a first control switch having two terminals, one terminal being connected to the energy storage unit and another terminal being connected to an inductor;
a second control switch connected in parallel to the first control switch;
a first diode connected between the first control switch and the inductor and adapted to allow a flow of current from the first control switch to the inductor; and
a second diode connected between the second control switch and the inductor and adapted to allow a flow of current from the inductor to the second control switch.

28. The PDP of claim 21, wherein the third level voltage and the fourth level voltage have the same magnitude and opposite polarity.
